(19) United States
(12) Patent Application Publication
(10) Pub. No.: US 2005/0254387 A1
(43) Pub. Date: Nov. 17, 2005

(54) Recording medium processing device

(75) Inventors: Tadashi Kojima, Yokohama-shi (JP); Atsushi Ishihara, Yokohama-shi (JP); Taku Kato, Kamakura-shi (JP); Shinichi Matsukawa, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/047,625

(22) Filed: Feb. 2, 2005

(30) Foreign Application Priority Data
Apr. 30, 2004 (JP) 2004-135562

(51) Int. Cl. G11B 5/09

(52) U.S. Cl. 369/59.1; 369/59.23; 369/47.1

(57) ABSTRACT

From a main information file including main information, and a specific information file which has two or more data blocks including specific information and has a data capacity of two or more times greater than a predetermined capacity, a plurality of error correction code blocks whose data capacity is the predetermined capacity are generated. A confidential information is embedded in the specific information in the generated plurality of error correction blocks. When the main information in the recording medium is rewritten in a unit of the error correction code block, the confidential information embedded in the specific information is protected because either of the two data blocks in the specific information file remains without being rewritten.

### CROSS-REFERENCE TO THE INVENTION

This application is based upon and claims the benefit of priority from the prior Japanese Patent Application No.2004-135562, filed on Apr. 30, 2004; the entire contents of which are incorporated herein by reference.

### BACKGROUND OF THE INVENTION

1. Field of the Invention

The present invention relates to a processing device for recording or reproducing main information in which confidential information is embedded on/from a recording medium.

2. Description of the Related Art

In some cases, confidential information that is not intended for disclosure to users is recorded on a recording medium such as a CD (Compact Disk) and a DVD (Digital Versatile Disk). For example, when various contents such as images, sounds, texts, and the like are encoded and recorded onto the recording medium, the encoded contents and an encryption key for decoding the contents as confidential information are recorded. This enables both reproduction of the contents and prevention of illegal copy thereof to thereby protect a copyrighted work contained in the contents.

A technique of embedding the confidential information in main information is disclosed (refer to Japanese Patent Application Laid-open No. Hei 9-128890, Japanese Patent Application Laid-open No. 2000-3560, Japanese Patent Application Laid-open No. 2003-132625, Japanese Patent Application Laid-open No. 2003-109302, and Japanese Patent Application Laid-open No. 2003-122637). By embedding the confidential information in the main information, it becomes possible to extract only the main information which does not include the confidential information by error correction processing, and to read out the confidential information only in a drive by special processing.

### SUMMARY OF THE INVENTION

It is usually the case that writing into a recording medium is performed in a unit of a certain quantity. In an optical disk, information is written therein in a unit of an error correction block (ECC block). In this case, when main information in an ECC block in which the main information and confidential information are mixed is rewritten, there is the possibility that the confidential information is destroyed. It is because,as a result of the rewriting by reading out information from the ECC block and rewriting after correction, the confidential information is removed by error correction processing in reading out the information from the ECC block, and only the main information is reproduced.

In order to prevent such destruction of the confidential information by rewriting the main information, a boundary of an embedding position of the confidential information may be made to coincide with a boundary of the ECC block. More specifically, sectors of the main information and sectors in which the confidential information is embedded are prevented from being mixed, so that writing into the sectors of the main information and writing into the sectors in which the confidential information is embedded can be separated.

However, since the ECC block is constituted of, for example, 16 sectors in a DVD, it is difficult to cause an interval of writing data and the boundary of the ECC block to coincide with each other in usual writing processing. As a result of this, it is difficult to completely prevent appearance of the ECC block in which the main information sector and the confidential information are mixed, and there is the possibility that the confidential information is damaged due to correction and writing of the main information.

In view of the above circumstances, it is an object of the present invention to provide a processing device which protects the confidential information in rewriting the main information.

A processing device according to the present invention. includes: a block generation unit configured to generate a plurality of error correction code blocks of predetermined data capacity, from a main information file including main information, and a specific information file having two or more data blocks including specific information, the specific information file having a data capacity of two or more times greater than the predetermined data capacity; a confidential information embedding unit configured to embed confidential information in the specific information in the plurality of error correction blocks being generated; and a writing unit configured to write the plurality of error correction blocks embedded the confidential information in a recording medium.

When the main information in the recording medium is rewritten in a unit of the error correction code block, the confidential information embedded in the specific information is protected because either of the two data blocks in the specific information file remains without being rewritten.

A processing device according to the present invention includes: a readout unit configured to read out from a recording medium an error correction block including two or more contiguous data blocks divided into logical sectors, the data blocks including specific information with embedded confidential information; a sector extraction unit configured to extract from the read-out error correction block the logical sectors which do not include main information; and a data block reproducing unit configured to reproduce the data block by arranging the extracted logical sectors.

### BRIEF DESCRIPTION OF THE DRAWINGS

FIG. 1 is a view showing a disk recording device according to a first embodiment of the present invention.

FIG. 2 is a schematic view showing the data frame structure.

FIG. 3 is a schematic view showing an ECC block to which an error correction outer parity PO and an error correction inner parity PI are generated and added.

FIG. 4 is a schematic view showing the ECC block in which the error correction outer parity PO is arranged in a dispersed manner.

FIG. 5 is a view showing a structural example of a MM file including a media mark signal.

FIG. 6 is a schematic view showing a physical sector into which the media mark signal is incorporated.

FIG. 7 shows an example when the MM file is connected to other data files and recorded on the recording medium.

FIG. 8 is a schematic view showing the arrangement relationship of MM blocks constituted of MM sectors in which the MM signal is embedded, when the recording medium is recorded in a unit of the ECC block.

FIG. 9 is a schematic view showing the MM file to which MM sector identification numbers are added.

FIG. 10 is a flowchart showing an example of a reproducing procedure of the MM block, when a part of the MM signal is disappeared due to a file adjacent to the MM block being rewritten.

FIG. 11 is a flowchart showing another example of the reproducing procedure of the MM block, when a part of the MM signal is disappeared due to the file adjacent to the MM block being rewritten.

FIG. 12 is a block diagram showing a disc recording device according to a second embodiment of the present invention.

FIG. 13 is a block diagram showing a recording/reproducing device according to a third embodiment of the present invention.

FIG. 14 is a view showing an example of an encoding procedure of contents according to a fourth embodiment of the present invention.

FIG. 15 is a view according to a fifth embodiment of the present invention, showing a decoding procedure of encoded contents.

FIG. 16 is a view showing relationship when contents are moved from a recording medium in which encoded contents are recorded to another recording medium.

FIG. 17 is a view showing an example of whole relationship in a comprehensive manner when recording, reproducing, movement and so on of a plurality of encoded contents are performed on/from/to a recording medium.

### DESCRIPTION OF THE EMBODIMENTS

Hereinafter, embodiments of the present invention will be explained with reference to the drawings.

### First Embodiment

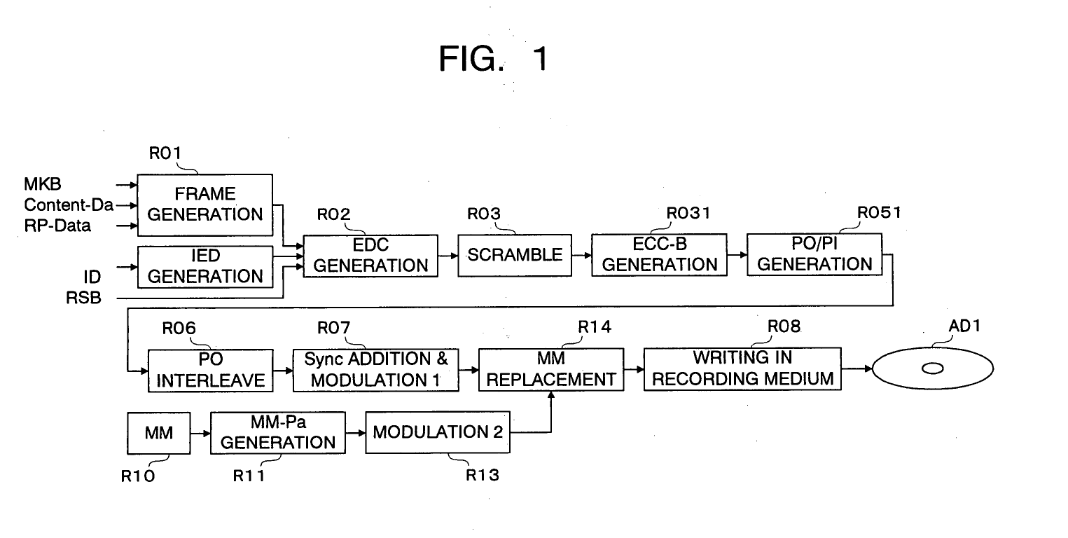

FIG. 1 is a view showing a disk recording device according to a first embodiment of the present invention.

Here, a media mark (MM) as confidential information is embedded in main information such as contents data and a media key block (MKB), and specific information such as proprietary data (RP-Data), to be written into a recording medium D.

The contents data is data representing images, sounds and so on. Since this contents data is encoded and then written into the recording medium D, the data is typically in the form of encoded contents (Enc-contents) which have been encoded before shown in FIG. 1. In this drawing, it is not necessary to distinguish contents before encoding (plaintext) from the encoded contents, and the encoded contents are therefore referred to simply as the contents data.

All of the media key block (MKB), the proprietary data (RP-Data), and the media mark (MM) are information for protecting the contents data.

The media key block (MKB) and the media mark (MM) are elements of an encryption key for decoding the encoded contents.

The proprietary data (RP-Data) is data to be a subject of ownership of a copyright, a trademark, a well-known name, or the like. When the proprietary data (RP-Data) is data having a characteristic of copyrighted work, such as data of images and sounds or the like, it becomes a subject of copyright. Further, when the proprietary data (RP-Data) exhibits a function of trademark, it can be a subject of trademark. One case of exhibiting the function of trademark is that a design of the trademark is reproduced when an optical disk 10 is set in a disk drive (reproducing device). This is because the proprietary data will be recognized as a trademark by a customer as a result of performing demonstration in a sales shop for example.

Here, the media key block (MKB) is regarded as the main information, the proprietary data (RP-Data) is regarded as the specific information, and the media mark (MM) is regarded as the confidential information, but this division is not absolute in a sense and a division different there from is also possible. In the narrow sense, the contents data can be considered as the main information. Meanwhile, supposing that what is processed with the contents data is regarded as the main information, and information embedded in the main information is regarded as the confidential information, it is possible to regard the specific information as a part of the main information.

The main information is inputted into a data frame generation unit R01 and arranged in a data frame structure constituted of a 2K-byte data packet. In parallel to this, an ID error detection code (IED) is added to a sector identifier (ID: Sector-ID) which corresponds to each data frame. The data frame generated in the data frame generation unit R01 is inputted into an EDC generation unit R02 where the sector identifier (ID) and reserve data (RSB) are added to the data frame and an error detection code (EDC) is generated and added to the data frame.

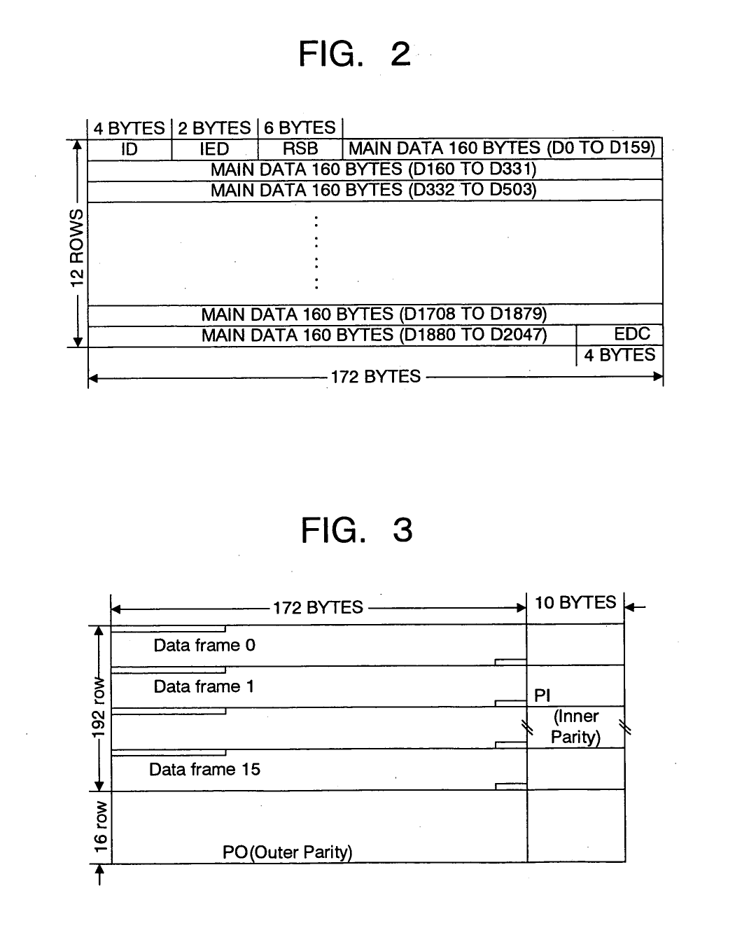

FIG. 2 is a schematic view showing the data frame structure generated in the data frame generation unit R01. The data frame is constituted of the sector identifier (ID), the ID error detection code (IED), the reserve data (RSB), the main data (contents data as the main information) and the error detection code (EDC).

The data frame outputted from the EDC generation unit R02 is inputted into a scramble unit R03 where a scramble signal is superimposed on the main information in the data frame. This scramble signal is typically decided based on a part of data of the sector identifier (ID). The data frame undergone the scramble processing is inputted into an ECC block generation unit R031 where an ECC block is generated from 16 sets of the data frames. The ECC block is inputted into a PO/PI generation unit R051 where an error correction outer parity PO and an error correction inner parity PI are generated and added to the ECC block.

FIG. 3 is a schematic view showing the ECC block outputted from the PO/PI generation unit R051, to which the error correction outer parity PO and the error correction inner parity PI are added. The error correction parities PO and PI are added to the data block which is constituted of the 16 sets of the data frames shown in FIG. 2 being aggregated.

The ECC block outputted from the PO/PI generation unit R051 is inputted into a PO interleave unit R06 where the error correction outer parity PO in the ECC block is arranged in a dispersed manner. As a result, the ECC block has a structure of aggregated recording sectors in which the error correction inner parity PI and the error correction outer parity PO are arranged in a dispersed manner and a part of the PO are added thereto.

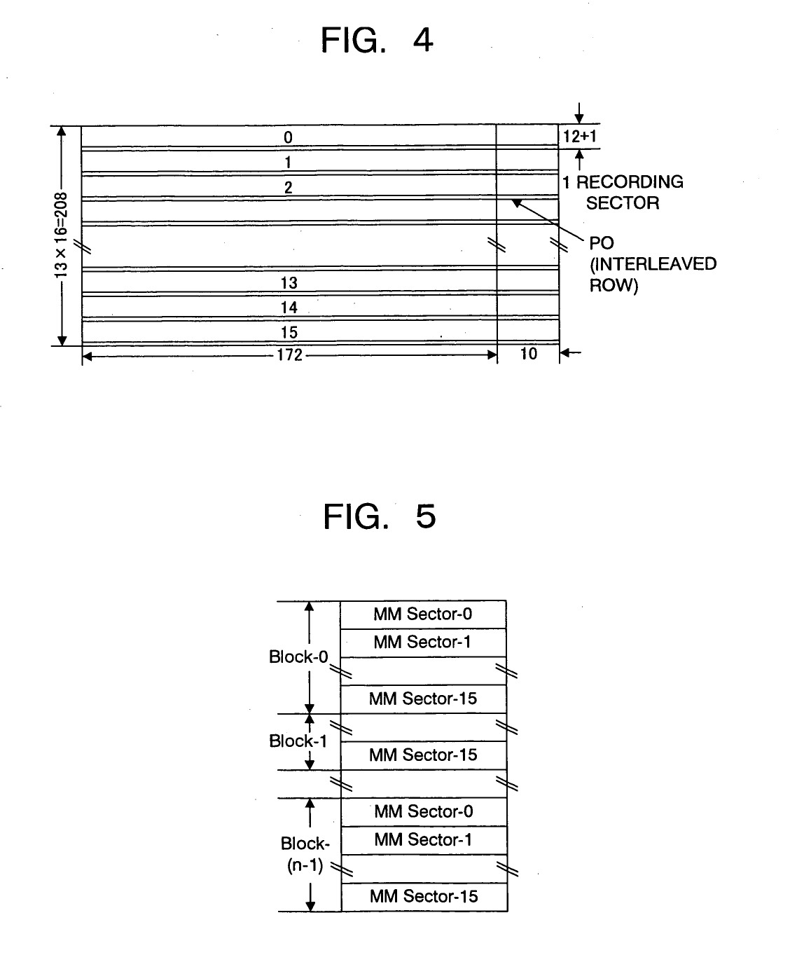

FIG. 4 is a schematic view showing the ECC block outputted from the PO interleave unit R06, in which the error correction outer parity PO is arranged in a dispersed manner. These recording sectors are subjected to modulation processing and added with a synchronization signal in a synchronization signal (Sync) addition & first modulation unit R07.

On the other hand, the media mark (MM) is added with a media mark (MM) dedicated error correction code (MM-Pa) in a media mark parity (MM-Pa) generation unit R11 to become a correcting code added media mark (MM+MM-Pa) and modulated in a second modulation unit R13.

FIG. 5 is a view showing a structural example of a MM file including a media mark signal outputted from the second modulation unit R13. Here, it is supposed that a block having the same capacity as that of the ECC block which is treated in a physical area is defined as a media mark (MM) block, and the MM file is constituted to have the size equal to or larger than the two MM blocks. In the case where a 2K-byte sector is a packet unit for file management, for example, the MM block is constituted of 16 MM sectors and the MM file is constituted of two or more MM blocks, when the ECC block is constituted of the 16 sectors. Incidentally, this will be explained later in detail.

The modulated recording sector and the modulated media mark are inputted into a media mark (MM) replacement unit R14 where a part of a main information modulation signal in the recording sector is replaced with a media mark modulation signal to generate a recording signal.

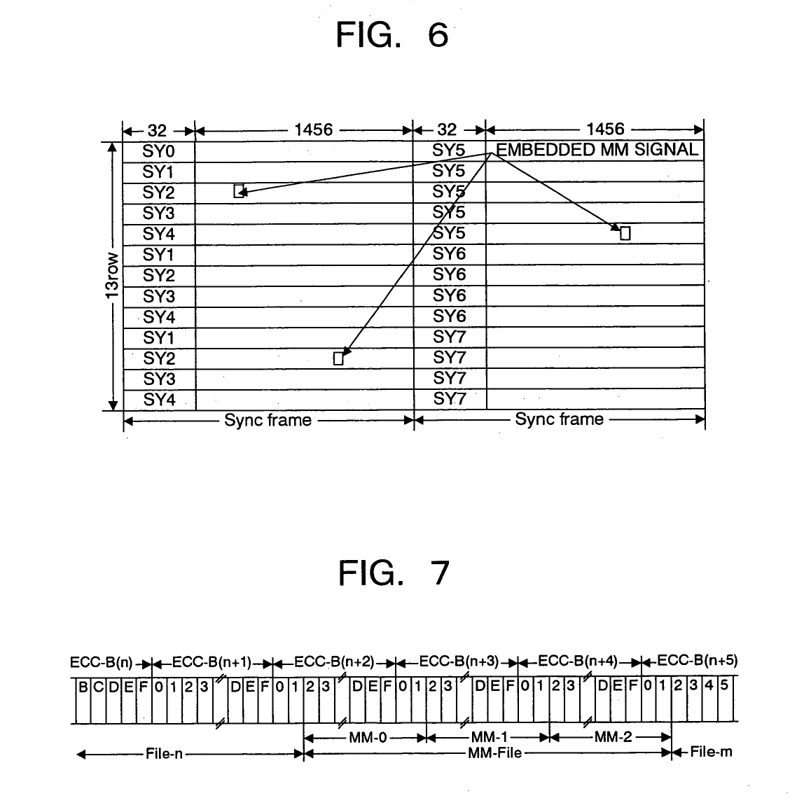

FIG. 6 is a schematic view showing a physical sector outputted from the media mark (MM) replacement unit R14, into which the media mark signal (MM) is incorporated. The media mark modulation signal (MM) is arranged in the plural physical sectors in a dispersed manner, thereby suppressing deterioration in error correction ability of the main information (improving restorability of the main information). Arrangement of the media mark modulation signal in a dispersed manner allows its confidentiality to improve.

This recording signal is written into the recording medium D by a recording medium writing unit R08.

As described so far, a part of the modulated main information is replaced with the specially modulated MM signal to be recorded on the recording medium, according to the present invention. The part where the MM signal is embedded in becomes error data during demodulation of the main information, and the main information is restored by error correction processing. Incidentally, during the demodulation, channel bits as a modulated data stream read out from the recording medium are demodulated and detected by a special demodulator for MM signal demodulation.

Hereinafter, the reason why the capacity of the MM file is made to be two or more times larger than that of the ECC block, as shown in FIG. 5, will be explained.

In the recording medium (Digital Versatile Disk (DVD), for example), data processing, recording and so on are typically performed in a unit of an aggregate of data of a certain quantity. For example, in the DVD, recording and reproducing of the recording medium are performed in a unit of the ECC block, which is the 16 sets of the connected data frames in 2K-byte units. Namely, the 2K-byte data frame is a basis of processing from a side of a data file of the contents, and the ECC block as an aggregate of 16 data frames is a basis of processing in recording and reproducing processing in a drive.

Breaking up the area of the ECC block further and managing which area in the ECC block corresponds to the data file on the side of the contents are not performed according to DVD standards. When a main information signal in which the MM signal is embedded (MM data file) is included in the ECC block, another data file may be included in this ECC block. In this case, an attempt to rewrite this another file causes rewriting of the entire ECC block. At this time, data in the ECC block is read out and a part of the read-out data is changed, thereby changing the data in the ECC block.

However, the embedded MM signal is disappeared by the error correction processing in reading out the data from the ECC block. This is because the MM signal is embedded so as to disappear in the error correction processing. (The MM signal is reproduced only in the drive and is not taken out therefrom. The MM signal is embedded using technology of so-called “electronic watermark that disappear”.)

There is the possibility that the MM signal disappears in correcting the data due to the fact that the file is thus managed in a unit of the ECC block. In other words, in a system in which a recording/reproducing packet of the data is defined in a unit of the sector, and the recording and reproducing of the recording medium are performed in a unit of the ECC block constituted of the plural data sectors (frames) aggregated together, it is impossible to fully eliminate the possibility that the MM signal disappears. If a boundary between the MM data file and another data file coincides with a boundary of the ECC block, such disappearance of the MM signal by correcting another data file can be prevented. However, it is difficult to realize it at all times.

Meanwhile, the present invention prevents the MM signal from being disappeared in rewriting the file, irrespective of the relationship between the boundary of the MM data file in which the MM signal is embedded and the boundary of the ECC block. This will be explained next.

FIG. 7 shows an example when the MM file defined as shown in FIG. 5 is connected to other data files and recorded on the recording medium.

Here, in the area of ECC blocks ECC-B(n) to ECC-B(n+5), a “file (n)”, “MM file” and “file (m)” are contiguously recorded. The file (n) is recorded up to a physical sector 1 of the ECC block “ECC-B(n+2)”, and the MM file is recorded from a physical sector 2 of the “ECC-B(n+2)” to a sector 1 of the “ECC-B(n+5)”. The file (m) is recorded from a sector 2 of the ECC block “ECC-B(n+5)” and afterward. Incidentally, the MM file is constituted of three MM blocks (MM-0) to (MM-2). It should be noted that a position of the sector in which the MM signal is embedded is the same in each MM block.

The capacity of the MM file in which the MM signal is embedded is made to be two or more times larger than that of the ECC block, with the result that the MM signal can be extracted wherever the physical boundary of the ECC block is arranged in the MM file. More specifically, supposing that the file (n) is rewritten after the MM file is recorded. At this time, the ECC-B(n+2) is rewritten and accordingly, the MM signal embedded in MM sectors S0 to S13 in the MM file (MM-0) disappears. However, the ECC blocks ECC-B(n+3) and ECC-B(n+4) are not rewritten, and hence two sets of the sectors in which the MM signal being not disappeared is embedded are secured. As a result, a reliable MM signal can be reproduced based on the two sets of the MM signal.

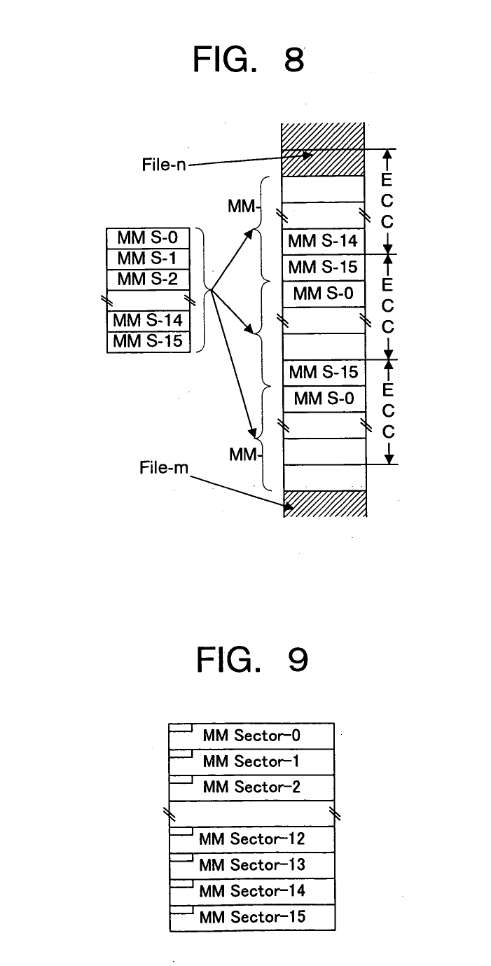

FIG. 8 is a schematic view showing the arrangement relationship of the MM blocks constituted of the MM sectors in which the MM signal is embedded, when the recording medium is recorded in a unit of the ECC block. Each of the sectors S0 to S15 in the MM block corresponds to the physical sector into which the media mark signal (MM) is incorporated as shown in FIG. 6.

Since the MM file is thus constituted having the capacity equal to the that of the two ECC blocks, it is possible to reproduce the MM signal using other MM sectors when a part of the sectors in the MM file is rewritten in rewriting the adjacent file. In other words, it is possible to reproduce the MM signal even when the boundary of the MM block does not coincide with the boundary of the ECC block.

It is clear from the above that the MM block can be reproduced when the two or more sets of the MM blocks are contiguously arranged and the capacity of the MM blocks set corresponds to the capacity of the two or more ECC blocks.

The ECC block in which the MM file and another file are mixed has the possibility that the MM file is destroyed by rewriting this another file. However, the ECC file which includes the MM file only(which does not include a regular file)is not destroyed. Namely, only the ECC blocks including the head of the MM block and the end thereof, among the contiguous MM blocks, have the possibility of being destroyed by rewriting the data, and the intermediate ECC block is not rewritten because it includes the MM block only. In this case, all the sectors of the MM block are included in this intermediate ECC block, and therefore it is possible to reproduce the original MM block.

At this time, when the MM sectors in the MM block can be distinguished, it is possible to easily reproduce the MM block using the distinguished result. For this purpose, MM sector identification information such as a MM sector identification number, by which the relationship between the MM sector and the MM block can be identified, may be included in the MM sector in itself. This MM sector identification number acts similarly to a physical sector number which is given to the physical sector in the ECC block.

FIG. 9 is a schematic view showing a MM file to which the MM sector identification numbers are added. The MM sector identification numbers are written into the respective MM sectors.

As described above, the MM file is constituted by embedding the MM signal in the main information signal. The main information here is not limited to the original main data such as the contents data. Namely, the main information here is information intended to be treated similarly to the regular main information and reproduced in the error correction processing, irrespective of its substantive contents. Therefore, it is possible to use dummy data as the main information signal in which the MM signal is embedded.

In this case, classification into a type A and a type B can be made according to the area into which the MM sector identification number is written.

(1) Type A

According to the type A,the MM sector identification number is written into the area of the main data.

1) For example, the main data may be constituted by repeating the MM sector number. In generating the recording signal, the main data is subjected to the scramble processing to become a random signal, and hence the MM sector number, that is, an embedding state of the MM signal is not easily found out from the recording signal.

2) The MM sector number and a random number pattern are brought into correspondence with each other in advance, and the random number pattern, instead of the MM sector number, can be recorded in the area of the main data. In this case, since the numbers in the random number pattern are inconsecutive apparently, the correspondence between the random number pattern and the MM sector identification number can be hidden easily.

3) When not only the MM sector identification number but also the MM block identification number are recorded in the area of the main data, processing of bringing the necessary, MM sectors together becomes easier.

(2) Type B

According to the type B, the MM sector identification number is written into the reserve area (RSB).

1) The MM sector identification number may be written into the reserve area (RSB) as it is. In this case, the MM sector identification number may be repeated, if the capacity of the reserve area (RSB) permits.

2) The random number pattern may be recorded instead of the MM sector number.

3) When not only the MM sector identification number but also the MM block identification number are recorded, processing of bringing the necessary MM sectors together becomes easier.

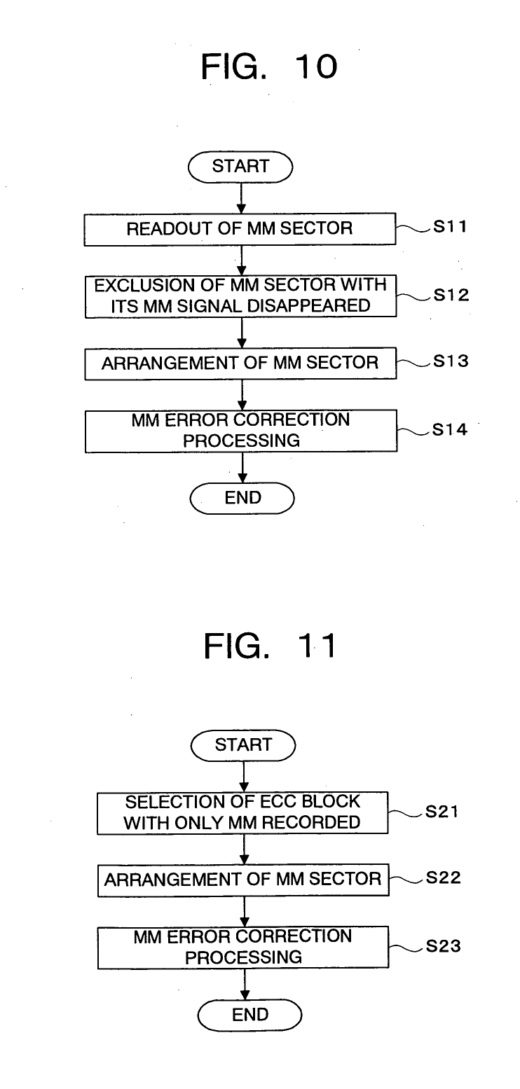

FIG. 10 is a flowchart showing an example of a reproducing procedure of the MM block, when a part of the MM signal is disappeared due to the file adjacent to the MM block being rewritten.

(1) The MM file is read out in a unit of the MM sector (Step S11)

(2) A judgment is made whether there is the possibility that the MM signal in the read-out MM sector is disappeared or not (Step S12). This judgment is made based on the MM block number, MM sector number, and ECC sector number of the read-out MM sector.

For example, supposing that the MM sector numbers in the MM block are in the order of 0 to F (15 in the decimal system), similarly to the ECC sector numbers in the ECC block. In this case, when the read-out MM sector is included in the first MM block, and the ECC sector number (low-order four bits) is larger than the MM sector number, there is the possibility that the MM signal is disappeared. Further, when the read-out MM sector is included in the last MM block, and the ECC sector number (low-order four bits) is smaller than the MM sector number, there is the possibility that the MM signal is disappeared. This is because, in the above cases, the read-out MM sector belongs to the ECC block including another file.

(3) The MM sectors without the possibility that the MM signal is disappeared therefrom are arranged in the order of the MM sector identification number, so that the MM block is reproduced (Step S13). In this case, a plurality of the MM sectors whose MM sector identification numbers are the same can exist, but either of these may be adopted if this is the case. This is because when the MM sector identification numbers are the same, the contents of the MM sectors are supposed to be the same.

(4) If necessary, the reproduced MM signal is subjected to the error correction processing to detect the reliable MM signal (Step S14). In order to realize this error correction processing, an error correction code of the MM signal needs to be added to the MM signal.

FIG. 11 is a flowchart showing another example of the reproducing procedure of the MM block, when a part of the MM signal is disappeared due to the file adjacent to the MM block being rewritten.

(1) The ECC block in which only the MM file is recorded is selected (Step S21).

When the two or more identical ECC blocks are contiguously arranged across the two or more ECC blocks, it can be expected that an element of the MM block is included in any of the ECC blocks.

At this time, the ECC blocks in which the head and the end of the MM file are included have the possibility that the MM signal is destroyed since the file other than the MM file and the MM file are mixed therein. In the ECC block excluding the head and the end, the MM signal is maintained, and the MM block can be reproduced therefrom. Incidentally, even if the head or the end is included in the ECC block, the MM file only is included in the ECC block and the MM signal is maintained, when the head or the end (boundary) of the MM block coincides with the ECC block.

Here, when the capacity of the MM block is made to be the same as that of the ECC block, it is possible to reproduce the MM block from only one ECC block.

(2) The MM sector numbers of the MM sectors in the read-out ECC block are read out, and the read-out MM sectors are arranged in the order of the MM sector number, so that the MM block is reproduced (Step S22).

(3) If necessary, the reproduced MM signal is subjected to the error correction processing to detect the reliable MM signal (Step S23). In order to realize this error correction processing, an error correction code of the MM signal needs to be added to the MM signal.

### Second Embodiment

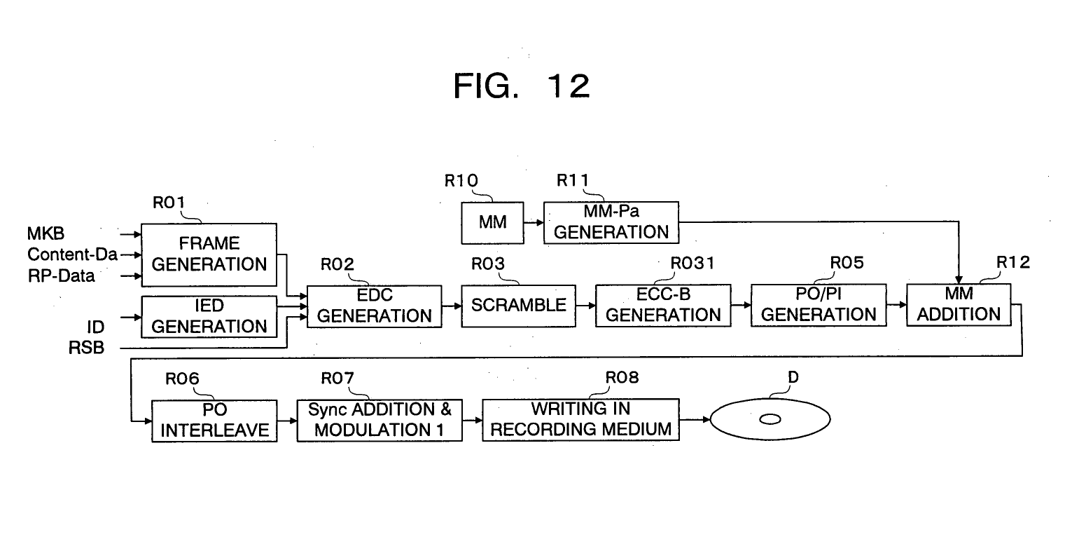

FIG. 12 is a block diagram showing a disc recording device according to a second embodiment of the present invention.

A data frame constituted of 2K-byte data as a pack is added with an ID, an error detection code and the like, subjected to scramble processing, and thereafter, 16 sets of the data frames are aggregated and an error correction inner parity (PI) and outer parity (PO) are generated and added thereto, so that an ECC block is constituted, similarly to the case shown in FIG. 1.

Here, after the generation of the PI & PO, (or after PO interleaving) a MM signal is superimposed on (added to) a part of data. The outer parity (P0) of the ECC block is subjected to row interleave processing to disperse one row of the PO to each data frame, so that an aggregate of 16 sets of recording data frames is constituted. While the MM signal is thus superimposed on a part of the data (including PI/PO areas), addition of a synchronization signal (sync) and modulation processing are performed and physical sectors are constituted to be recorded on a recording medium.

In this case, a part in which the MM signal is embedded also becomes error data in demodulation of main information, and the main information is restored by error correction processing. By extracting an error pattern detected in the process of the error correction processing of the main information, the MM signal is reproduced.

### Third Embodiment

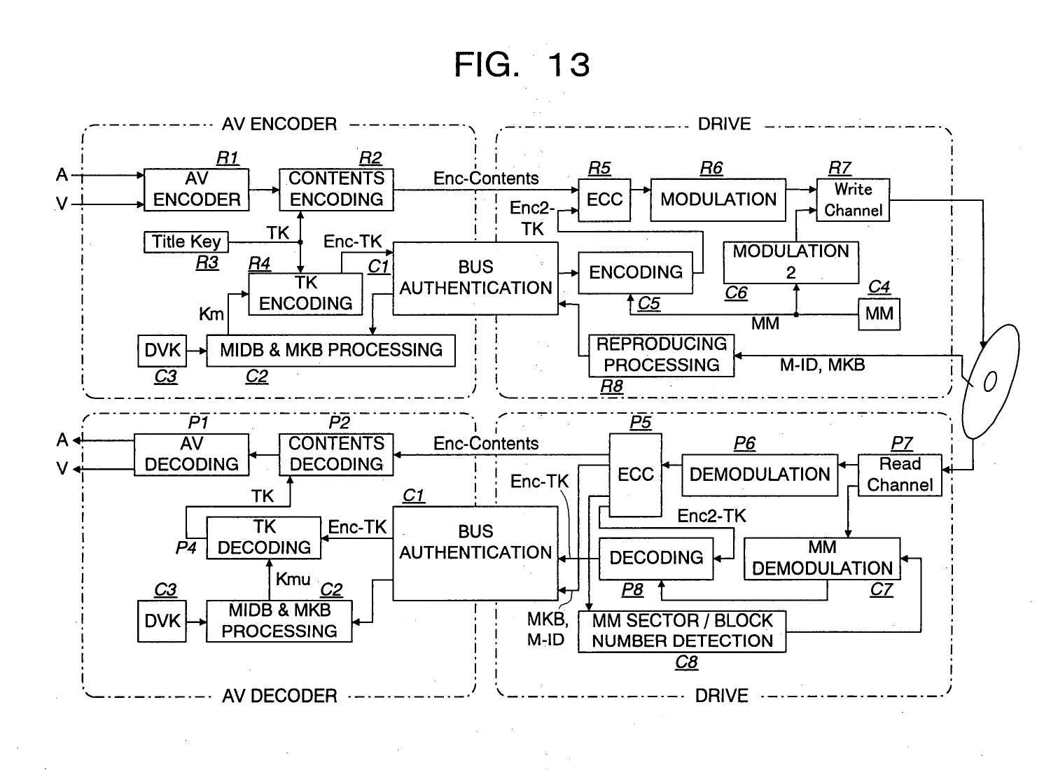

FIG. 13 is a block diagram showing a recording/reproducing device according to a third embodiment of the present invention.

The upper half of FIG. 13 shows encoding of contents and recording the contents on a recording medium.

In an AV encoder module, audio and visual (AV) data as the contents is encoded at an AV encoder R1, and encoded using a title key (TK) at a contents encoding unit R2. This encoded contents (Enc-Contents) is added with an error correction code (at ECC addition unit R5) and subjected to modulation processing (at modulation processing unit R6) in a drive, to be recorded on the recording medium by a writing channel unit R7.

The title key (TK) used in contents encoding is encoded using a media specific key (Km) by a title key encoding unit R4, to become an encoded title key (Enc-TK). This media specific key (Km) is generated by a device key set (DVK), a media identifier (M-ID) and a media key block (MKB) read out from the disc by a reproducing processing unit R8 (at MIDB & MKB processing unit C2).

The encoded title key (Enc-TK) is sent from the AV encoder module to the drive, multiply encoded using a media mark (MM) signal at an encoding unit C5 and, as a multiply encoded title key (Enc2-TK), added with the error correction code (at ECC addition unit R5) and subjected to the modulation processing (at modulation processing unit R6), to be recorded on the recording medium by the writing channel unit R7.

The MM signal is added with a correction code for MM signal or encoded (a global secret key can be used) as necessary, modulated by a modulator C6 which is different from the one used for main information, and replaced with a part of modulated main information at the writing channel unit R7, to be recorded on the recording medium.

At this time, the main information in which the MM signal is embedded is constituted of dummy data including a MM block number and a MM sector number. In other words, the dummy data in which the MM signal is embedded constitutes a MM file.

The lower half of FIG. 13 shows reproducing the encoded contents from the recording medium.

The MM signal which is read out from the recording medium by a reading channel unit P7 is demodulated (at MM demodulation unit C7). In this demodulation, the MM block and MM sector number are detected from the MM file (MM sector/block number detection unit C8), which are used for reading out a MM modulation signal from the designated position and detecting the reliable MM signal by the MM demodulation unit C7.

The multiply encoded title key (Enc2-TK) is read out from the disc through the reading channel unit P7, a demodulation unit P6 and an error correction processing unit (ECC) P5, and decoded using the MM signal at a decoding unit P8, to reproduce the encoded title key (Enc-TK). The encoded title key (Enc-TK) is sent out to an AV decoder module, decoded using the media specific key (Kmu), to become the title key (TK). This media specific key (Kmu) is generated by the device. key set (DVK), the media identifier (M-ID) read out from the disc and the media key block (MKB) by the reproducing processing unit R8 (at MIDB & MKB processing unit C2).

Next, the encoded contents are read out and decoded using the title key, so that plaintext contents are reproduced.

As described so far, the recording/reproducing device according to this embodiment encodes and decodes the contents using the MM signal embedded in the main information signal.

### Fourth Embodiment

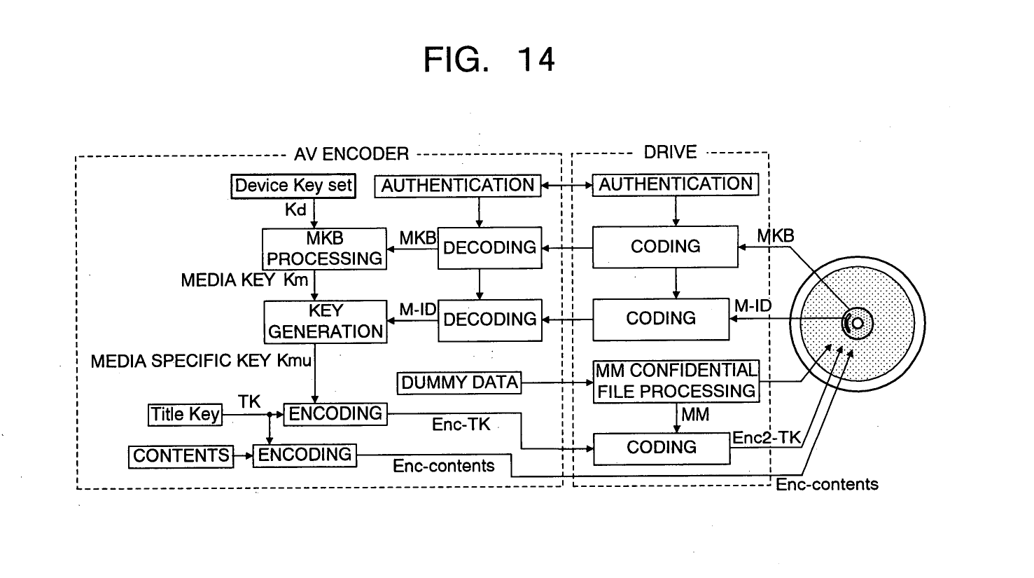

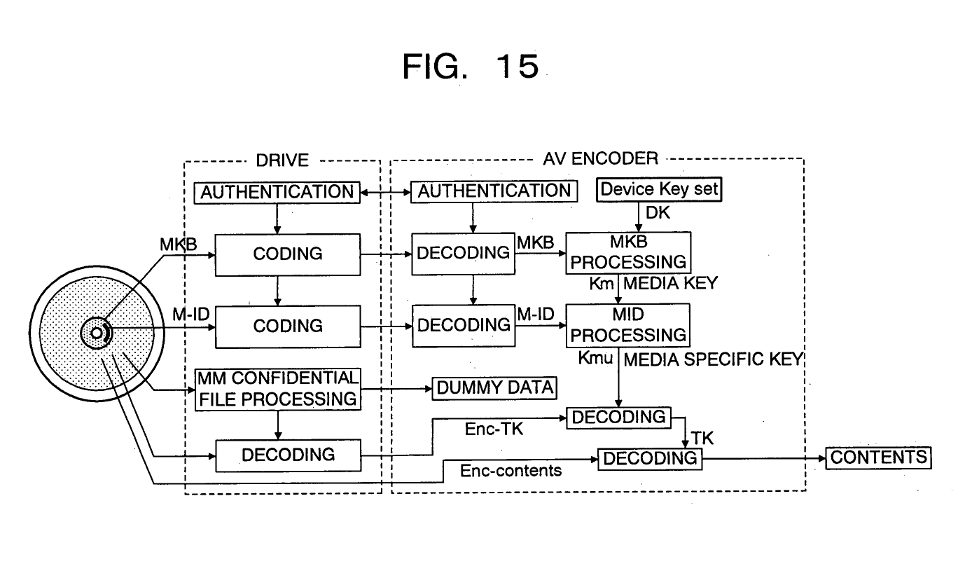

FIG. 14 is a view showing an example of an encoding procedure of contents according to a fourth embodiment of the present invention.

A title key of a contents encryption key is encoded using a media specific key (Kmu). An encoded encryption key (Enc-TK) which is encoded at an AV encoder unit is multiply encoded using confidential information MM in a drive, and recorded on a recording medium as a multiply encoded encryption key (Enc2-TK).

At this time, a media mark (MM) as the confidential information is embedded in a file constituted of dummy data, and used in an encryption key management system as data which can be extracted only in the drive.

### Fifth Embodiment

FIG. 15 is a view according to a fifth embodiment of the present invention, showing a decoding procedure of contents encoded by the procedure shown in FIG. 14.

A title key is multiply encoded and recorded on a recording medium. In decoding processing of the recording medium, a MM signal as confidential information is detected in a drive. Then, a multiply encoded title key (Enc2-TK) recorded on the recording medium is decoded using the MM signal. Since an encryption key decoded in the drive is an encoded encryption key (Enc-TK) encoded using a media specific key (Kmu), decoding processing is performed at an AV data processing unit to extract a title key (TK), so that encoded contents (Enc-contents) are decoded.

### Sixth Embodiment

A sixth embodiment of the present invention will be explained.

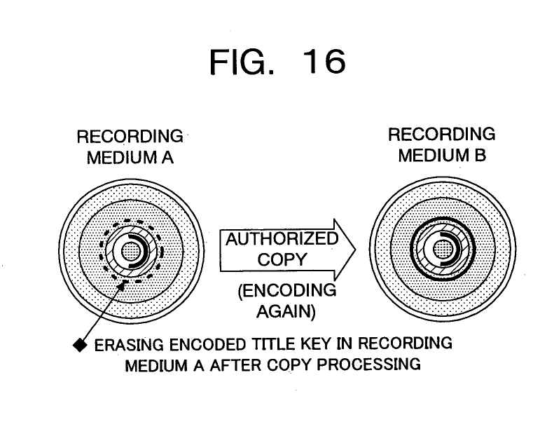

FIG. 16 is a view showing relationship when contents are moved from a recording medium in which encoded contents are recorded to another recording medium.

In a recording medium A, the encoded contents (Enc-contents), a multiply encoded title key (Enc2-TK(a) ) and so on are recorded. The encoded contents (Enc-contents) are read out from the recording medium A, decoded, and thereafter encoded using a new title key (TK(b)), to be recorded on a recording medium B. The title key (TK) becomes a multiply encoded title key (Enc2-TK(b)) by a media identifier (M-ID), a media key block (MKB) and a MM signal, to be recorded on the recording medium B. Thereafter, the multiply encoded title key (Enc2-TK(a)) and the MM signal are erased from the recording medium A so that the contents cannot be reproduced from the recording medium A.

According to such contents movement processing, a number of the contents is regulated and at the same time the contents are permitted being arranged freely, and hence it is more convenient for users as compared with the case of simply inhibiting copying. Here, since it takes time to fully erase the encoded contents from the recording medium A, the multiply encoded title key (Enc2-TK (a)) and the MM signal are erased, instead of erasing the encoded contents.

The multiply encoded title key (Enc2-TK(a)) cannot be decoded to reproduce a title key (TK(a)) unless the MM signal as confidential information is used. Therefore, it is possible to prevent the title key (TK(a)) from being reproduced by unauthorized means.

The following action may be taken. That is, the multiply encoded title key (Enc2-TK(a)) is read out in advance from the recording medium A. Then, after the contents are moved from the recording medium A to the recording medium B and the multiply encoded title key (Enc2-TK(a)) and the MM signal are erased, the multiply encoded title key (Enc2-TK(a)) and the MM signal which are read out in advance are rewritten into the recording medium A. Incidentally, even when areas in which the multiply encoded title key (Enc2-TK(a)) and the MM signal exist are not clear, areas which have the possibility of including these may be widely read out and rewritten.

Even though an attempt is made to reproduce the recording state of the recording medium A using the above means, the MM signal is destroyed in error correction processing in reading out and hence it is impossible to read it out. Therefore, regeneration of the encoded contents recorded on the recording medium A can be prevented.

### Seventh Embodiment

A seventh embodiment of the present invention will be explained.

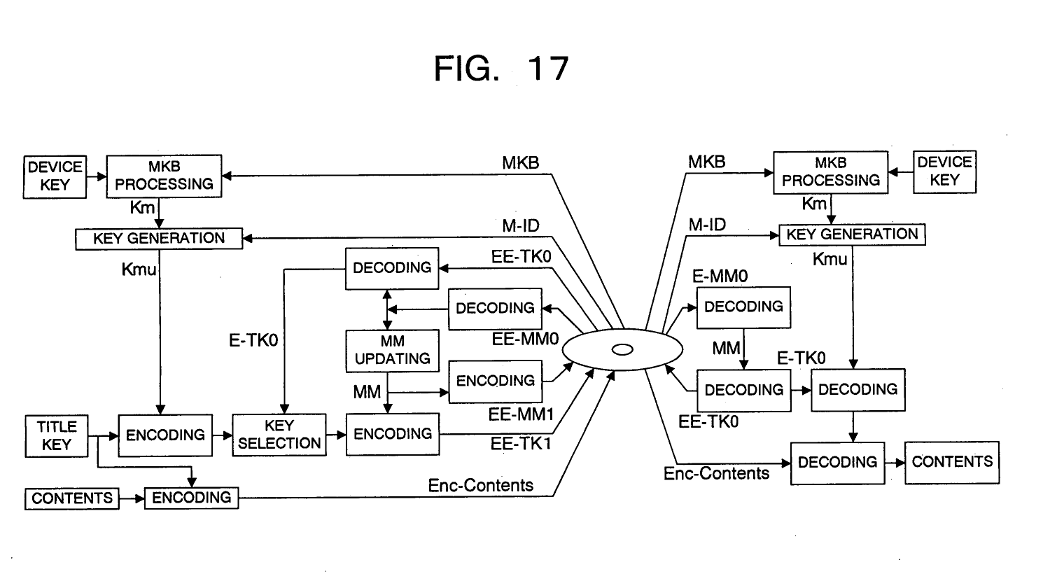

FIG. 17 is a view showing an example of whole relationship in a comprehensive manner when recording, reproducing, movement and so on of a plurality of encoded contents are performed on/from/to a recording medium, in processing procedures shown in FIG. 14 and FIG. 15.

In the example shown in the drawing, a MM signal as an encoded MM signal (E-MM0) which is encoded using a global secret encryption key, together with a multiply encoded title key (EE-TK0, that is, a contents encryption key which is multiply encoded) are recorded on the recording medium.

Here, when the plural encoded contents are recorded on the same recording medium, title keys (TK) that are different from each other are made to correspond to the plural encoded contents respectively, thereby facilitating new recording, movement processing and reproducing processing on an individual basis.

The plural encryption keys (title keys (TK)) exist corresponding to the respective contents, whereas only one set of confidential information data (MM signal) exists. When rewriting, erasing or the like of the contents is performed using any one of the plural encoded encryption keys, the MM signal and the encoded encryption key which is encoded using it are updated. More specifically, the encoded MM signal (E-MM0) is updated to become an encoded MM signal (E-MM1), and the multiply encoded title key (EE-TK0) is updated to become a multiply encoded title key (EE-TK1), respectively.

Incidentally, the title keys corresponding to the continuing contents are held as they are. This is to prevent the existing encoded contents from being encoded again and rewritten.

Such updating processing of the key easily prevents the contents from being copied in an unauthorized manner, when a part of the encoded contents is subjected to movement processing (erased after the movement) from the recording medium on which the plural encoded contents are recorded, and additional recording and reproducing processing of the contents are performed on the same recording medium.

The preexisting encoded contents and the additional encoded contents can be decoded using the new encoded MM signal (E-MM1) and new multiply encoded title key (EE-TK1). Meanwhile, in the erased contents, the new encoded MM signal (E-MM1) and multiply encoded title key (EE-TK1) are not generated, instead of erasing the actual contents. As a result, it is impossible to decode this encoded contents. Namely, even though the multiply encoded title key (EE-TK0) before updating can be obtained, the encoded contents cannot be reproduced because the MM signal is updated.

The encoded MM signal (E-MM0) and the multiply encoded title key (EE-TK0) are updated as follows. The MM signal is updated and encoded, to be recorded on the recording medium as the encoded MM signal (E-MM1). For example, the MM signal which is read out and decoded as the encoded MM signal (E-MM0) is counted up in a MM updating unit, so that the MM signal is updated.

The multiply encoded title key (EE-TK0) is read out from the recording medium and decoded using the MM signal (MM0) decoded from the encoded MM signal (E-MM0), so that the encoded title key (E-TK0) is generated. Incidentally, when a part of the plural title keys (TK0) is changed or added, the erased part or the added part of the title key (TK0) is rewritten.

This encoded title key (E-TK0) is multiply encoded using the updated new MM signal (MM1), to be recorded on the recording medium as the multiply encoded title key (EE-TK1).

### Other Embodiments

Embodiments of the present invention are not limited to the above-described embodiments, and extension and changes may be made. Such extended and changed embodiments are also included in the technical scope of the present invention.

1. A processing device, comprising:
a block generation unit configured to generate a plurality of error correction code blocks of predetermined data capacity, from a main information file including main information, and a specific information file having two or more data blocks including specific information, the specific information file having a data capacity of two or more times greater than the predetermined data capacity;
a confidential information embedding unit configured to embed confidential information in the specific information in the plurality of error correction blocks being generated; and
a writing unit configured to write the plurality of error correction blocks embedded the confidential information in a recording medium.

2. A processing device according to claim 1,
wherein a data capacity of the data block is equal to the predetermined capacity.

3. A processing device according to claim 1,
wherein the error correction block and the data block are respectively divided into sectors.

4. A processing device according to claim 3,
wherein a number of the sectors constituting the error correction block and a number of the sectors constituting the data block are equal to each other.

5. A processing device according to claim 3,
wherein the sector of the data block includes sector identification information identifying the sector.

6. A processing device according to claim 3,
wherein the same specific information is included in the corresponding sectors in the different data blocks.

7. A processing device according to claim 3,
wherein the same confidential information is embedded in the corresponding sectors in the different data blocks.

8. A processing device according to claim 5,
wherein the sector identification information is arranged in an area of main information of the sector.

9. A processing device according to claim 5,
wherein the sector identification information is arranged in an reserve area of the sector.

10. A processing device according to claim 1,
wherein said confidential information embedding unit comprises a replacement unit configured to replace a part of the specific information in the plurality of error correction blocks with the confidential information.

11. A processing device according to claim 1,
wherein said confidential information embedding unit comprises an addition unit configured to add a part of the specific information in the plurality of error correction blocks and the confidential information.

12. A processing device according to claim 1,
wherein said block generation unit comprises:
a data frame generation unit configured to generate a data frame from the specific information file and the main information file;
an error detection code addition unit configured to add an error detection code to the generated data frame;
a scramble unit configured to superimpose a scramble signal on the data frame added with the error detection code;
an error correction block generation unit configured to generate an error correction block from the scrambled data frame; and
an error correction outer parity/inner parity addition unit configured to add an error correction outer parity and inner parity to the generated error correction block.

13. A processing device according to claim 12,
wherein the error correction block generation unit comprises:
an interleave unit configured to interleave the error correction outer parity of the error correction block to which the error correction outer parity and inner parity are added; and
a modulation unit configured to modulate the interleaved error correction block.

14. A processing device according to claim 1,
wherein the confidential information constitutes at least a part of an encryption key decoding encoded contents.

15. A processing device, comprising:
a readout unit configured to read out from a recording medium an error correction block including two or more contiguous data blocks divided into logical sectors, the data blocks including specific information with embedded confidential information;
a sector extraction unit configured to extract from the read-out error correction block the logical sectors which do not include main information; and
a data block reproducing unit configured to reproduce the data block by arranging the extracted logical sectors.

16. A processing device according to claim 15,
wherein said sector extraction unit comprises a block selection unit configured to select the error correction block not including the main information from the read-out error correction block.

17. A processing device according to claim 15,
wherein the error correction block is divided into the logical sectors, and
said sector extraction unit extracts the logical sector from the data block based on correspondence between the logical sector and a physical sector of the error correction block corresponding to the logical sector.

18. A processing device according to claim 15,
wherein the two or more data blocks respectively comprises the same specific information.

19. A processing device according to claim 15, further comprising:
an error correction unit configured to error correct to the reproduced error correction block.
